(19) United States
(12) Patent Application Publication
(10) Pub. No.: US 2009/0155740 A1
(43) Pub. Date: Jun. 18, 2009

(54) Ultrasonic Dental Treatment System

(75) Inventors: Steven D. Jensen, South Jordan, UT (US); Densen Cao, Sandy, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: CAO GROUP, INC., West Jordan, UT (US)

(21) Appl. No.: 12/198,234

(22) Filed: Aug. 26, 2008

Related U.S. Application Data
(63) Continuation-in-part of application No. 11/961,557, filed on Dec. 20, 2007.
Application No. 11/961,557 is a continuation of application No. 10/913,702, filed on Aug. 6, 2004, now abandoned.
(60) Provisional application No. 61/060,806, filed on Jun. 11, 2008.

(51) Int. Cl. A61C 3/03; A61C 17/16

(52) U.S. Cl. 433/119; 433/216

(57) ABSTRACT

The present invention is a personal ultrasonic dental hygiene device. A handle with an ultrasonic transducer is provided with differing dental hygiene attachments for personal use. The device may be powered through a battery or through direct wall socket communication. A variety of controls may be provided to adjust ultrasonic frequency and treatment time.

### CROSS-REFERENCES TO RELATED APPLICATIONS

This Application claims priority as a Continuation-in-Part Application of prior filed U.S. application Ser. No. 11/961,557, filed Dec. 20, 2007, which is in turn a Continuation Application of Prior filed U.S. Application number 10/913,702, filed Aug. 6, 2004, now abandoned. This Application is also a non-provisional perfection of prior filed U.S. Provisional Application 61/060,806, filed Jun. 11, 2008. All of these Applications are incorporated herein by reference in their entirety.

### FIELD OF THE INVENTION

The present invention relates to the field of devices for oral tissue treatments and more particularly relates to a portable ultrasonic device designed for professional and personal dental use.

### BACKGROUND OF THE INVENTION

The use of ultrasonic waves in various healing techniques is known, including use in wound healing. Ultrasonic technology has also been used in dentistry for the removal of plaque. Ultrasonic devices in dentistry fall into two categories: toothbrushes and scalers. Ultrasonic toothbrushes use ultrasonic waves along with toothpaste to help in the loosening of plaque and debris from on and between teeth and along the gingival margin. Ultrasonic scalers utilize an ultrasonic transducer to generate ultrasonic energy, which is conducted to a narrow tip. The said tip works along with a liquid solution, either water or a mixed chemical, to achieve a cavitation effect and remove plaque on the teeth or the sub-gingival area so as to maintain teeth health. In both cases, the tool itself utilizes ultrasonic energy along with a working media to physically remove debris from the teeth and gingiva and require contact with the debris to move it. Ultrasonic waves are also known to have anti-bacterial qualities (see, U.S. Pat. No. 5,611,993).

Periodontal disease results from the formation of bacteria, growing on the surfaces and roots of the teeth. There are several diseases, like heart disease and diabetes, found to be related to the same bacteria which result in periodontal disease. Therefore, the treatment of periodontal disease is very critical to human health. Currently there are few effective treatments of periodontal disease. One of the best ways to combat periodontal disease is prevention, however, there are few devices on the market today, other than the toothbrush and rinses, designed to maximize personal oral upkeep. This is especially true for devices using ultrasonic waves and their benefits as they are primarily relegated to the professional realm.

The present invention is a handheld ultrasonic dental treatment system that includes a tray or a set of trays, toothbrush and other tools. Being handheld it is powered from a battery pack which may be rechargeable or replaceable, or directly from a home wall outlet. The device may include microprocessors and sensors to determine ideal ultrasonic wavelengths, or may be a manually controlled tool, with the user selecting desired or recommended frequencies and time. Ideally, dental tools such as the tray, brush and picks, are interchangeable for the device and the device should have ideal settings for the use of each tool available to it.

The present invention represents a departure from the prior art in that the ultrasonic treatment device of the present invention allows for a ultrasonic device for use in both professional and personal dental treatment paradigms.

### SUMMARY OF THE INVENTION

In view of the foregoing disadvantages inherent in the known types of dental devices, this invention provides an ultrasonic dental treatment system. As such, the present invention's general purpose is to provide a new and improved dental system that utilizes ultrasonic waves to enhance performance of dental treatments.

To accomplish these objectives, the system comprises a handheld unit containing control circuitry and at least one ultrasonic transducer. The unit also features mounting hardware for interchangeable dental tools such as a bleaching tray, a toothbrush and a pick. Power is supplied, ideally, through a rechargeable battery—though other power supplies such as replaceable batteries or a wall outlet may be used. Controls on the unit may be as simple as a power switch, or may include digital displays and controls to vary treatment time and/or ultrasonic frequency. The system may be contained in an organizational unit that may also serve as a recharging base. Another embodiment comprises a handheld unit containing control circuitry and an ultrasonic transducer with a permanently affixed dental tool, such as a dental tray and support fork assembly as described in the parent application.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a depiction of an ultrasonic device setup capable of use in the present method.

FIG. 2 is a perspective view of an ultrasonic transducer and conducting fork, used in the system of FIG. 1.

FIG. 3 is a depiction of an ultrasonic transducer with cover, conducting fork and tray on the conducting fork, for use in the system of FIG. 1.

FIG. 4a is a perspective view of a single arch treatment fork and tray.

FIG. 4b is a perspective view of a double arch treatment fork and tray.

FIG. 5 is a perspective view of the transducer assembly and a single arch tray.

FIG. 6 is a top plan view of a simple embodiment of the hand unit of the present invention with a dental tray.

FIG. 7 is a schematic view of a system according to the present invention.

### DETAILED DESCRIPTION OF THE PREFERRED EMBODIMENT

With reference now to the drawings, the preferred embodiment of the treatment method is herein described. It should be noted that the articles “a”, “an”, and “the”, as used in this specification, include plural referents unless the content clearly dictates otherwise.

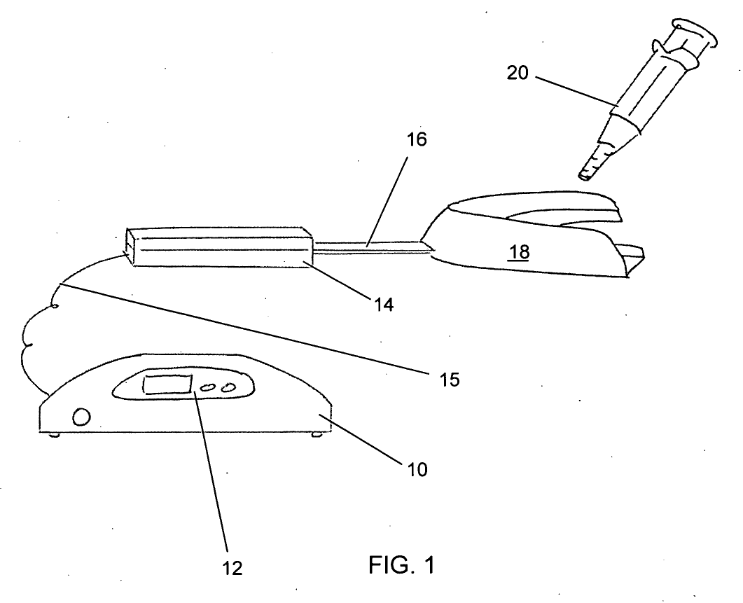

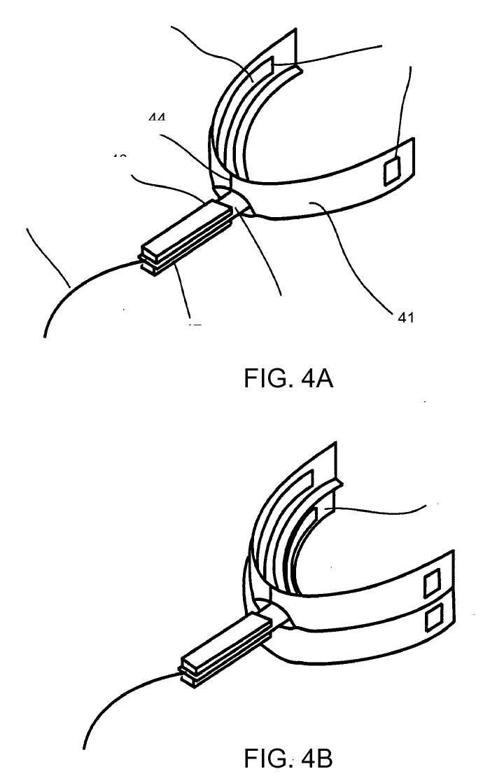

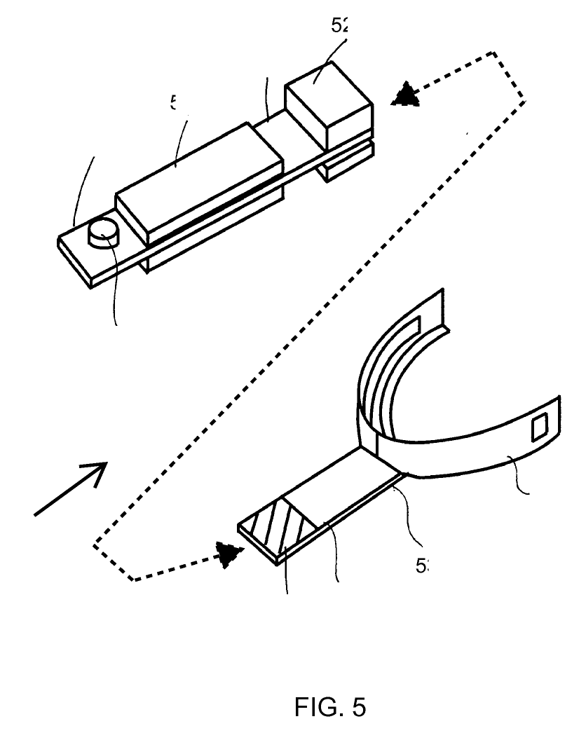

An desktop ultrasonic device is disclosed in the Parent application Ser. No. 11/961,557, which has already been incorporated by reference. This application will describe the preferred embodiment of the equipment (corresponding to the devices shown in FIGS. 800, 1000, and 1100 of the Parent Application, the latter two being reproduced here as FIGS. 4, and 5), though any device depicted in the Parent Application will suffice. FIG. 1 illustrates the basic setup of treatment system of the parent application, where 10 is an electronic control unit with an electronic display and adjustment controls 12. The control unit is electrically powered. Conduction cord 15 then is connected to the transducers 14. Treatment trays 18 are added to on the fork prior to insertion in the consumer's mouth.

Fork tang 16 connects the fork tines (obscured by the tray) to the transducers 14. The shape and size of the tines are designed to cover entire or most of or partial of upper or lower arch. The function of the trays is to allow each fork to closely contact the teeth and gingival surface. In so doing, ultrasonic energy is efficiently conducted to the treatment surface. Forks should be made of a material that resists oxidation and transmits ultrasonic energy well—such as stainless steel. Other materials, such as plastics, composites, different metals, may be used to construct the fork so long as they are capable of withstanding and transmitting and distributing the ultrasonic waves and, if desired, capable of being autoclaved. Plastics that would be suitable in an autoclavable tool include: phenolics, nylons, polycarbonates, poly ether ether ketone (PEEK), high density polyethylenes, PETE, and poly(tetrafluoro ethylene). The list of plastics may be expanded for disposable tools. The trays may also hold treatment gels 20 proximate the treatment surface, if the gels are needed.

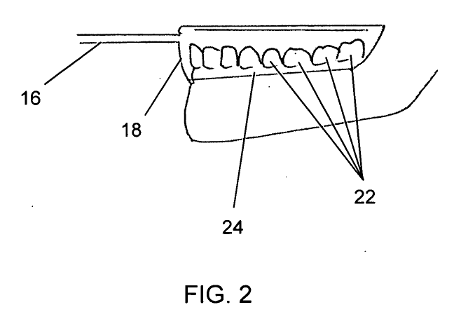

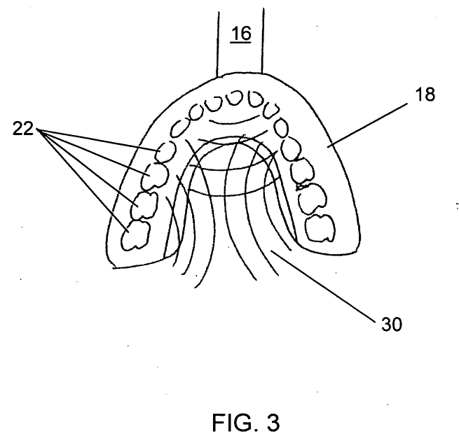

An individual fork used in treatment is depicted in FIG. 2. Fork tang 16 supports fork and associated tray 18 and serves as a mount for transducer not shown. The tray 18 must be sufficient to allow fork placement with some degree of comfort and hygiene. The tray should also cover the teeth 22 and gingiva 24 of the consumer. If a treatment gel is used, or if the treatment method is using the consumer's own saliva, the tray 18 contains the gel. When activated (FIG. 3), ultrasonic waves 30 proceed from the fork and into the patient's mouth, stimulating the oral tissues and tooth structure, activating ingredients in the treatment gels, and also moving the treatment gels into better contact with the tissues.

Alternate fork embodiments are shown in FIGS. 4a and 4b, utilizing a double tray system. In this concept the transducers 46, 47 are mounted to the tang 45 of a fork. At a point 440 the tang converts into two tines of the fork 42, 43. A flexible, elastomeric tray 41 is constructed such that is may be attached to the fork tines 42, 43 for the course of treatment and then may be removed and discarded. As can be seen in the figures, the fork tines 42, 43 have a vertical (orthogonal) orientation with respect to the tang 45. This is merely a preference of design as the fork tines 42, 43 could be horizontal (parallel) to the tang 45 as well and the method will still function. Other fork constructions are possible. All that is required is that the fork be capable of supporting the dental tray 41 while also being capable of conducting ultrasonic energy from the transducer into the oral cavity and towards the desired oral tissues, either teeth or gingiva. To this point, a series of rods or wires may be used instead of the plates depicted.

When the tray 41 is in placed on the fork 42, 43 the user may apply treatment gels inside the tray 41 such that the gels are in indirect contact with the tines 42, 43. Treatment gels may be of any type that may be useful in dental treatment, most typically tooth whitening gels and/or periodontal preventatives or medicaments. Such gels may also specifically lend themselves to ultrasonic activation or may simply rely on the ultrasonic waves to facilitate penetration of and movement around oral tissues. The assembly is then placed in the consumer's mouth and the treatment is carried out as prescribed. The transducer(s) 46, 47 are powered by way of electrical wires 48 that would, subsequently interface with the control circuitry such as the control circuitry contained within the handheld unit. The use of a fork affords the ability to configure placement of the ultrasonic or sonic energy transmission in several locations targeting the teeth and gingiva. For instance the fork could be designed to be positioned on the vertical walls of the tray, or on the floor of the tray, or positioned between two trays, or two sets of fork arms could come of off the transition point 44 to facilitate a second tray or extension 49 of the existing flexible tray 41 as illustrated in FIG. 4b. In FIG. 4b, the arms are positioned against the vertical walls of both trays, i.e. four arms distributed in the two trays. Use of the dual arch tray depicted in FIG. 4b will allow for simultaneous treatment of both upper and lower dental arches of the consumer.

An assembly 51 for connecting the tools to an ultrasonic transducer is depicted in FIG. 5. The tool, in this case tray assembly 53, includes an insertion portion 53 and a protrusion portion 52. The insertion portion 53 is intended to be inserted into a consumer's mouth and the protrusion portion 52 is intended to protrude from the consumer's mouth. The insertion portion 53 has a tray section 53a and a projection section 53b. Of course, whatever the tool is desired to be, which could include a toothbrush, scaler or pick, will determine the configuration of the insertion portion. For the depicted tray, the tray section may include a reservoir or other geometry or feature for retaining a quantity of therapeutic gel adjacent to a consumer's teeth and/or gingiva. The projection section would project from a consumer's mouth when the tray section is inserted into the consumer's mouth. The projection section may include an attachment 53c for attachment into the protrusion portion 52, which includes the transducer assembly, by use of a clamp, clasp 52a or other mechanism. The transducer assembly is contained in the handheld unit and has an elongate body 52b on which one or more ultrasonic transducers 52c (such as EDO EC-70, 1.7″×0.4″×0.032″; fL=+/−31 kHz). An electrical attachment 52d is provided for powering the transducer assembly. When the transducer is powered, ultrasonic waves are transmitted to the tray (and the associated gels and tissues) through the structures mentioned above. If desired, the structures can be designed for greater than 50% ultrasonic energy transmission, greater than 60%, greater than 70%, greater than 80% or greater than 90%.

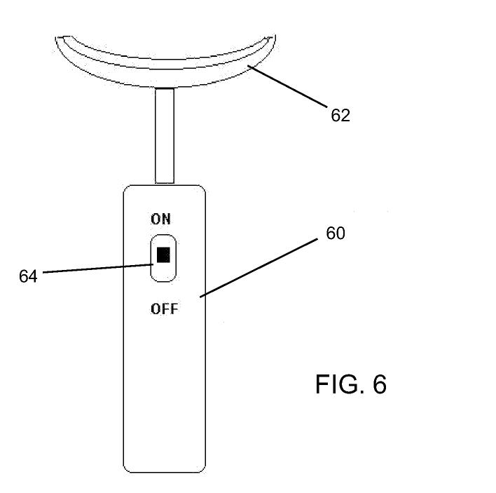

With reference to FIG. 6, the conversion of the professional system to a consumer system yields a system primarily comprising a handheld unit 60 with at least one tool, such as the bleaching tray 62 depicted in the figure. The unit is powered with a simple switch 64 and may be battery powered and cordless as shown for maximum freedom of movement. Such a unit would have a preprogrammed cycling for a specific treatment procedure, such as bleaching. In the case of whitening, a whitening compound is added to the tray and the tray inserted and held in the user's mouth, over an arch of teeth. The unit is then activated and the cycle begins. When finished, the user repeats for the other arch. Such devices may be made for other tools and treatment regimens, including tooth brushing, pick utilization, gingival treatment to reduce periodontal disease, etc. In this embodiment, the tray is an extension of, and is of one piece with, the fork.

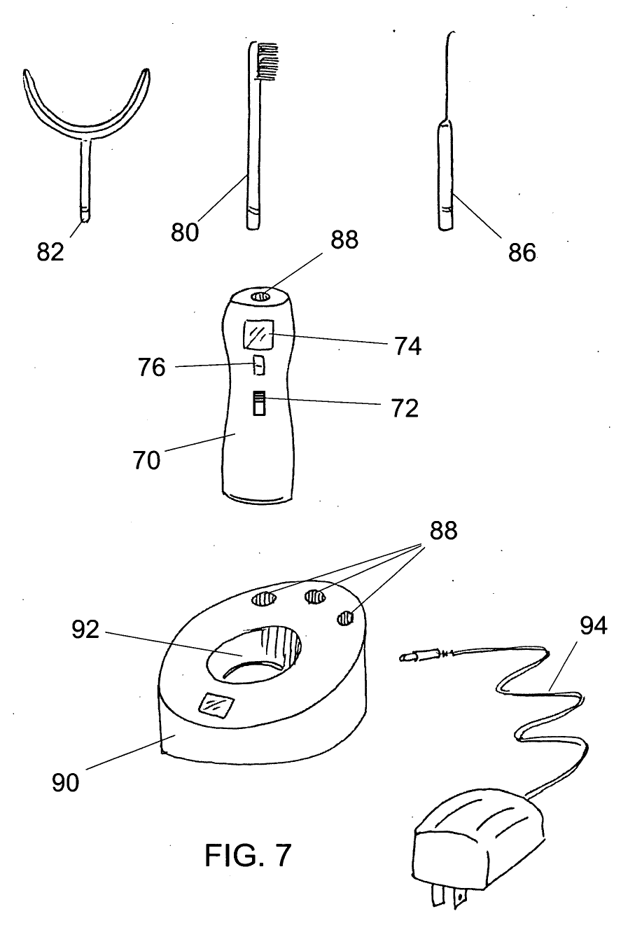

A preferred embodiment is shown in FIG. 7, where unit 70 has a number of attachments and controls for a number of procedures. Not only does unit 70 have a power switch 72, but also a digital display 74 and selection switches 76 to vary the program. Such a unit could have various treatment regimens pre-programmed as to time of regimen and frequencies used, with simple selection by the user through the selection switches, or can be totally modifiable by the user. In the system depicted, the unit has a toothbrush attachment 80, a tray attachment 82 and a dental pick attachment 86, all of which attach in a slot 78 of the unit. Other tool configurations are possible, including duplicates of the same tool, such as identifiable toothbrushes, so an entire family may enjoy the benefits of the unit. When placed in slot 78, a tool is in contact with an ultrasonic transducer for conduction of the ultrasonic waves into the chosen tool attachment. The unit 70 depicted in the figure is powered by a rechargeable battery through base 90, which also contains ports 88 for the attachments and a recharging port 92 for the unit. Power is supplied though cord 94 for recharging the battery. As stated before, other powering means can be provided, including a direct plug-in to a wall power outlet or a disposable battery.

The frequencies generated may encompass the entire ultrasonic range, which is typically 20 kHz up to 3 MHz. Particular efficacy has been noted in the low frequency end, below 300 kHz and exceptional efficacy at 28 kHz and at related frequencies due to resonance doubling. The control unit may direct a sweeping frequency, covering a range from 20 kHz to 250 kHz, over the course of the treatment. Treatment times may vary depending upon the case. Preventative treatment may take place from a minute up to 60 minutes, depending on consumer conditions. In theory, a consumer may incorporate daily ultrasonic treatment into a dental treatment regimen for maximum results. Gels may include medicaments which may in turn include known and future discovered pharmaceuticals, including anti-microbial and anti-viral compounds, and nutraceuticals. Such medicaments could include chlorhexidine gluconate.

While the invention has been described as being on with removable and selectable dental tools, it is also within the scope of this invention for an ultrasonic device with a single, non-removable tool—this is most viable for the dental treatment tray. As the elastomeric tray is removable and designed to be a disposable component, not only can standard dental hygiene protocols, dictating regular change in dental tools like toothbrushes, be maintained without replacing the unit, but an entire family can share a single unit.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A personal ultrasonic treatment device comprising:
a. At least one ultrasonic transducer encased in a handle;
b. Connection means in the handle allowing wave communication to the ultrasonic transducer;
c. At least one dental treatment attachment with a corresponding attachment means for removable connection with the handle while maintaining communication, while attached, with the transducer.

2. The device of claim 1, the at least one dental treatment attachment being selected from the list of attachments consisting of: a toothbrush, a dental pick, a dental scaler, a dental treatment tray, and a dual arch dental treatment tray, said dental trays further comprising an ultrasonic conductive support covered by an elastomeric cover that is designed to hold a treatment gel proximate at least one dental arch, wherein the support conducts ultrasonic waves to at least one portion of a dental arch.

3. The device of claim 1, a plurality of different attachments being provided for attachment to the device.

4. The device of claim 3, the plurality of different dental treatment attachments being selected from the list of attachments consisting of: a toothbrush, a dental pick, a dental scaler, a dental treatment tray, and a dual arch dental treatment tray, said dental trays further comprising an ultrasonic conductive support covered by an elastomeric cover that is designed to hold a treatment gel proximate at least one dental arch, wherein the support conducts ultrasonic waves to at least one portion of a dental arch.

5. The device of claim 1 being powered by a power source selected from the set of power sources consisting of: disposable batteries, rechargeable batteries, and an AC wall outlet.

6. The device of claim 1, the transducer capable of generating ultrasonic waves between 20 and 250 kHz, inclusively.

7. A personal ultrasonic treatment device comprising:
a. at least one ultrasonic transducer encased in a handle;
b. connection means in the handle allowing wave communication from the ultrasonic transducer;
c. a dental treatment tool in communication with the connection means and capable of receiving ultrasonic wave from the transducer;
wherein, the device is powered by a power source that allows for personal handheld use.

8. The device of claim 7, the dental treatment tool being selected from the list of tools consisting of: a toothbrush, a dental pick, a dental scaler, a dental treatment tray, and a dual arch dental treatment tray, said dental trays further comprising an ultrasonic conductive support covered by an elastomeric cover that is designed to hold a treatment gel proximate at least one dental arch, wherein the support conducts ultrasonic waves to at least one portion of a dental arch.

9. The device of claim 7, a plurality of different tools being provided for attachment to the device, each tool being selectively attachable and detachable from the device.

10. The device of claim 9, the plurality of different dental hygiene tools being selected from the list of attachments consisting of: a toothbrush, a dental pick, a dental scaler, a dental treatment tray, and a dual arch dental treatment tray, said dental trays further comprising an ultrasonic conductive support covered by an elastomeric cover that is designed to hold a treatment gel proximate at least one dental arch, wherein the support conducts ultrasonic waves to at least one portion of a dental arch.

11. The device of claim 7 being powered by a power source selected from the set of power sources consisting of: disposable batteries, rechargeable batteries, and an AC wall outlet.

12. The device of claim 7, the transducer capable of generating ultrasonic waves between 20 and 250 kHz, inclusively.

13. The device of claim 12, the dental hygiene tool being selected from the list of tools consisting of: a toothbrush, a dental pick, a dental scaler, a dental treatment tray, and a dual arch dental treatment tray, said dental trays further comprising an ultrasonic conductive support covered by an elastomeric cover that is designed to hold a treatment gel proximate at least one dental arch, wherein the support conducts ultrasonic waves to at least one portion of a dental arch.

14. The device of claim 12, a plurality of different tools being provided for attachment to the device, each tool being selectively attachable and detachable from the device.

15. The device of claim 14, the plurality of different dental hygiene tools being selected from the list of attachments consisting of: a toothbrush, a dental pick, a dental scaler, a dental treatment tray, and a dual arch dental treatment tray, said dental trays further comprising an ultrasonic conductive support covered by an elastomeric cover that is designed to hold a treatment gel proximate at least one dental arch, wherein the support conducts ultrasonic waves to at least one portion of a dental arch.

16. The device of claim 12 being powered by a power source selected from the set of power sources consisting of: disposable batteries, rechargeable batteries, and an AC wall outlet.

17. The device of claim 7, the tool being a dental treatment tray, the tray comprising:
a. a fork tang extending from the device, being in ultrasonic communication with the at least one ultrasonic transducer;
b. a plurality of fork tines branching from the tang in a manner sufficient to position the tines about at least one dental arch;
c. an elastomeric tray designed to fit over at least two tines and receive a consumer's at least one dental arch, said elastomeric tray also being removable from the fork tines for replacement and cleaning;
wherein the device transmits ultrasonic waves along the tang and into the tines, and from there the ultrasonic waves are transmitted to a consumer's teeth and gingiva.

18. The device of claim 17, the elastomeric tray being capable of receiving both of a consumer's dental arches simultaneously and allowing, then, simultaneous treatment of the same.

19. The device of claim 17, the tray also being configured to receive a dental treatment gel.

20. The device of claim 19, the elastomeric tray being capable of receiving both of a consumer's dental arches simultaneously and allowing, then, simultaneous treatment of the same.

21. The device of claim 7, the tool being a dental treatment tray, the tray comprising:
a. a fork tang extending from the device, being in ultrasonic communication with the at least one ultrasonic transducer;
b. a plurality of fork tines branching from the tang in a manner sufficient to position the tines about at least one dental arch;
c. a tray formed from at least two tines and capable of receiving a consumer's at least one dental arch;
wherein the device transmits ultrasonic waves along the tang and into the tines, and from there the ultrasonic waves are transmitted to a consumer's teeth and gingiva.

22. The device of claim 17, the tray being capable of receiving both of a consumer's dental arches simultaneously and allowing, then, simultaneous treatment of the same.

23. The device of claim 17, the tray also being configured to receive a dental treatment gel.

24. The device of claim 19, the tray being capable of receiving both of a consumer's dental arches simultaneously and allowing, then, simultaneous treatment of the same.
